(19) United States
(12) Patent Application Publication
(10) Pub. No.: US 2005/0194882 A1
(43) Pub. Date: Sep. 8, 2005

(54) Color cathode ray tube with optical filter system

(76) Inventors: Hans-Helmut Bechtel, Roetgen (DE); Harald Glaser, Freiburg (DE); Joachim Opitz, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/513,013

(22) PCT Filed: Apr. 30, 2003
(86) PCT No.: PCT/IB03/01658

§ 371 Date: Oct. 28, 2004

(30) Foreign Application Priority Data
May 2, 2002 (DE) 102-19-595.1

(51) Int. Cl. H01J 29/89; H01J 29/10

(52) U.S. Cl. 313/461

(57) ABSTRACT

A color cathode ray tube provided with a front shell having an inner and an outer surface and a display screen coating on the front shell comprising a structured phosphor coating with phosphor grids for the colors red, green and blue and a filter system comprised of a first structured optical filter of the transmission type for the color blue and of a second unstructured optical filter.

The invention relates to a color cathode ray tube, particularly a color display tube or a color monitor, provided with a front shell with an inner and an outer surface and with a display screen coating on the front shell comprising a structured phosphor coating with phosphor grids for the colors red, green and blue and an optical filter system.

Color display screens and color monitors are frequently used in bright ambient light conditions. In order to improve the visibility of the image in ambient light conditions and reduce visual fatigue, the display screen should be characterized by absence of glare, a low level of reflection and a high contrast. In this respect, the quality of the display screen is determined less by the absolute brightness than by the contrast K. Contrast is to be taken to mean the difference between the highest and the lowest brightness. The contrast is calculated from the ratio of the sum of the external light intensity and the useful light intensity to the external light intensity.
K=(Iₑₓₜₑᵣₙₐₗ+I_{useful})/Iₑₓₜₑᵣₙₐₗ

Ambient light of intensity I_{ambient} is scattered back by the phosphor layer and must twice traverse the display screen glass. It then has the intensity Iₑₓₜₑᵣₙₐₗ=R_{screen}×I_{ambient}×T². In said equation, R_{screen} is the reflection coefficient of the phosphor layer, T is the transmission of the display screen glass.

The light of intensity Iₚᵢₓ emitted by the phosphor dots traverses the glass once and thus generates the useful luminance I_{useful}=Iₚᵢₓ×T. If reflection losses and scattered light losses are not taken into account, the contrast K obtained in practice is
K=(I_{ambient}×R_{screen}×T²+Iₚᵢₓ×T)/I_{ambient} R_{screen} T²

The contrast can be maximized by reducing the ambient light influence in relation to the intrinsic light emitted by the phosphor dots. This can be achieved in various ways, such as by reducing the transparency T of the display screen glass. Alternatively, however, use can be made of color filters in the form of inorganic pigments, which are selected such that they exhibit maximum transparency to the color emitted by the phosphor in question and absorb the other spectral components, so that diffuse reflection of ambient light is suppressed by a reduction of R_{screen} at the phosphor powder.

Thus, the colored pigments must absorb only external light, and not the emitted characteristic radiation. An adaptation to this effect is possible to a limited extent only, i.e. brightness losses will occur in any case.

A high contrast, and yet low brightness losses, can be achieved by means of a sandwich coating comprised of a pigment grid for the optical filters which is provided on the front shell and a corresponding phosphor grid provided thereon. This type of display screen coating, however, is very expensive and the coating process must be carried out six times in all for the three colors used in color cathode ray tubes.

A less expensive display screen coating is proposed in U.S. Pat. No. 5,942,848, which comprises a combination of red and blue color filter grids, i.e. a green color filter grid is dispensed with.

It is an object of the invention to provide a color display tube with improved luminance and higher contrast obtained by a simple combination of phosphor grids and optical filters.

In accordance with the invention, this object is achieved by a color cathode ray tube provided with a front shell having an inner and an outer surface and a display screen coating on the front shell comprising a structured phosphor coating with phosphor grids for the colors red, green and blue and a filter system comprised of a first structured optical filter of the transmission type for the color blue and of a second unstructured optical filter.

This filter system causes the color purity and the contrast of the color display screen to be improved. Its manufacture is uncomplicated and leads to a reduction of the manufacturing costs.

A further advantage of this arrangement is that a smaller percentage of the light energy outside the desired light wave range is converted to thermal energy. At the same time, the filter system blocks the specular reflexes at the inner surface of the glass front shell.

In accordance with an embodiment of the invention, the second optical filter is arranged on the inner surface of the front shell.

In accordance with yet another embodiment of the invention, the second optical filter is arranged on the outer surface of the front shell.

It has been found that the variation of the transmission Tₒₚₜ of the second optical filter in the visible wavelength range should be smaller than 2.

What is preferred is an embodiment of the invention wherein the transmission T₆₀₀ of the second optical filter for light having a wavelength λ=600 nm is greater than the transmission T₅₅₀ for light having a wavelength λ=550 nm.

In accordance with another preferred embodiment of the invention, the transmission T₄₅₀ of the second optical filter for light having a wavelength λ=450 nm is greater than the transmission T₅₂₀ of the second optical filter for light having a wavelength λ=520 nm.

If use is made of such a filter system, an improvement of the LCP (Luminance Contrast Performance) of up to 20% can be achieved, LCP being defined as the quotient of white luminance L_{w} and the root of the diffuse reflection √W_{diff}, i.e. LCP=L_{w}/√W_{diff}.

Suitable materials for the first optical filter include as a constituent an inorganic pigment selected from the group composed of cobalt aluminate CoAl₂O₄, ultramarine blue or phtalocyanine blue.

Suitable materials for the second optical filter include as a constituent an inorganic pigment selected from the group composed of cerium sulphide Ce₂S₃, β-indium sulphide β-In₂S₃, hematite α-Fe₂O₃, tantalum oxide nitride TaON or an organic dye selected from the group composed of chlorinated thioindigo Vat Red 54, dichlorodiketo-pyrrolopyrrole PR 254 (Irgazin, Ciba-Geigy), dichloro-quinacridone PR 202 (Mikrolith Magenta, Ciba-Geigy) and zapon violet 506 S.V. 2 (BASF).

These and other aspects of the invention are apparent from and will be elucidated with reference to the embodiment(s) described hereinafter.

A color display tube comprises the so-termed electron gun with the beam generating and beam focusing system for the three primary colors red, blue and green, as well as a beam deflection system and the color display screen inside an evacuated glass bulb.

The color display screen itself is made up of a front shell, which is part of the glass bulb, and the display screen coating on the inner surface of the color display screen having an effective image area that is generally essentially rectangular.

The display screen coating is generally made up of a plurality of layers. In addition to the phosphor coating with the R, G and B phosphors, the makeup of the coating generally also includes a black matrix to preclude the superposition of dyes between the phosphors and a rear-side metallization forming a reflective surface on the phosphor grid as a result of which the brightness is increased by 100%.

The layer that contains the phosphors is generally composed of a regular grid of color dots or color lines, which is divided into three sub-grids for the three primary colors that, when excited by an electron beam, luminesce in the primary colors red, green and blue.

The display screen coating in accordance with the invention differs from the display screen coatings in accordance with the state of the art by the presence of a filter system that is composed of a first optical filter and a second optical filter.

The first optical filter is a structured, optical transmission filter for blue. In order to spectrally clean the light emitted by the blue phosphor grid, use is made of a structured filter that absorbs all spectral components with the exception of the desired emission wavelengths. Said filter is grid-structured and arranged below the blue sub-grid of the phosphor layer.

This first optical filter is highly selective. It has a spectral transmission characteristic that corresponds to the phosphor for blue, i.e. it has a selective transmission with a spectral transmission distribution having an absorption minimum around 450 nm. In the maximum emission wavelength range of the blue phosphor ±70 nm, the transmission is higher than in the remaining wavelength range of the visible light between 400 and 650 nm.

To attain this optical transmission characteristic, the material that is used for the first filter layer may be a suitable organic or inorganic pigment or a dye; however, it is alternatively possible to mix two or more suitable organic or inorganic pigments or dyes for this filter layer.

Suitable pigments for the blue filter are, for example, cobalt aluminate CoAl₂O₄ (cobalt blue), ultramarine blue and phtalocyanine blue. These pigments for the blue filter have a transmission of approximately 70% and higher for light having a wavelength in the maximum emission range of the blue phosphor ±70 nm. On the other hand, their transmission in the other ranges of the visible spectrum is approximately 40%. This means that red and green light are intensively absorbed.

The pigment used for the first optical filter preferably has a particle size in the range of several hundred nanometers or less to improve the optical transparency. What is also important is that the pigments are uniformly distributed in the filter layer without agglomeration.

Furthermore, the inner or outer surface of the front shell is provided with a second optical filter that covers the entire effective image area.

Said second optical filter is laid out as a reflex-reducing, broadband-absorbing non-selective filter.

The second optical filter is used to transmit or reflect the regions of the electromagnetic radiation having a wavelength, respectively, above or below the visible region and filter out the intermediate region.

The transmission of the second optical filter is such that it combines a high transmission factor in the visible wavelength range with a low transmission factor in the other wavelength ranges. As a result the energy of the undesirable wavelength components in the visible red, green and blue wavelength range is controlled and reduced.

If necessary, the ratio of the components of the neutral filter can be set to be such that blue light is slightly stronger absorbed than green light, while red light is hardly attenuated. For such a second optical filter the following relation for the spectral transmission characteristic is obtained:
T₆₀₀>T₅₅₀>T₄₂₅

Consequently, the second optical filter has its maximum absorption in the wavelength range wherein the sensitivity of the eyes is greatest, and a lower absorption in the wavelength range where the sensitivity of the eyes is smaller.

Preferably, the second optical filter has its maximum absorption in a wavelength range from 500 to 600 nm, particularly at 575±20 nm, attenuates light in the range between 530 and 600 nm, and allows light of different wavelengths to pass more or less unobstructed. Particularly light having the maximum wavelength from the red and green phosphor is only slightly attenuated. As a result the color purity is improved and the natural colors are better reproducible. This can be attributed to a material-inherent absorption by filter pigments or lacquers whose absorption window lies in the spectral region to be blocked.

Materials having a suitable material-inherent broadband absorption include the inorganic filter pigments cerium sulphide Ce₂S₃, β-indium sulphide β-In₂S₃, hematite α-Fe₂O₃, tantalum oxide nitride TaON and organic dyes such as chlorinated thioindigo Vat Red 54, dichlorodiketo-pyrrolopyrrole PR 254 (Irgazin, Ciba-Geigy), dichloro-quinacridone PR 202 (Mikrolith Magenta, Ciba-Geigy) and zapon violet 506 S.V. 2 (BASF).

As it is difficult to obtain the desired optical characteristic by the use of a single pigment or dye, use is preferably made of a mixture of two or more organic or inorganic pigments or dyes. The spectral position of the broadband absorption can be set through the ratio of the constituents in the mixture.

The second optical filter is embodied so as to be a single-layer thin-film coating made from a suitably selected and composed material. The choice of the material enables the transmission to be adjusted. The residual reflection can be optimized so that only a small neutral reflection remains.

A sol-gel process which is known per se from U.S. Pat. No. 5,717,282 is preferably used to apply the pigments and dyes for the second optical filter while using alkoxy silanes. For this purpose, for example, a solution of tetraethyl orthosilicate in alcohol is mixed with the appropriate organic or inorganic pigment or dye and applied to the glass front shell by means of spin-coating. Subsequently, the layer is dried, hydrolysis of the alkoxy silane compounds resulting in the formation of SiO₂ as the solid binder for the pigment or the color lake.

The combination of the blue transmission filter and the neutral filter causes the color point of the green phosphor to be shifted into the yellow range. This can be evened up by using, instead of the customary green phosphor ZnS:Cu,Ag, the cheaper green phosphor ZNS:Cu, which saving in cost is a highly desirable side effect.

In accordance with an embodiment of the invention, the display screen coating for the color cathode ray tube in accordance with the invention can be produced using a filter system of a structured transmission filter for blue and a non-structured neutral filter by means of the following process steps:
cleaning the surface of the glass faceplate;
applying an unstructured neutral-filter layer using the sol-gel method;
applying a structured black matrix layer using the lift-off method;
applying the structured filter layer for the transmission filter for blue by means of negative lithography;
manufacturing one or more phosphor layers using a wet-chemical photolithographic process such as blade-coating, flow-coating or similar processes;
applying the rear-side metallization;
firing on the display screen coating at 400° C. accompanied by burning out the organic polymers.

The manufacturing process of the display screen coating customarily begins with cleaning and drying the glass front shell.

To coat the screen with the second filter, first a suitable dispersion of the pigments or a solution of the color particles in a solvent is prepared. In addition to the solvent and a binder, the dispersion may comprise various additives for influencing the stability of the dispersion or the solution.

Next, the front shell is, if necessary, first provided with the pattern of a black matrix by means of photolithography. Said black matrix is arranged on the inner surface of the glass front shell. Said black matrix is structured such that it covers the surfaces that are not occupied by the phosphor grid. The subsequent process by which the blue filter is manufactured will generally depend on the photolithographic manufacturing process by which the phosphor layers to be provided above it at a later stage are to be produced.

To manufacture a color filter layer for the blue filter, a suitable pigment to which dispersing aids are added is dispersed in water by using a stirring apparatus or a mill. A suspension of primary particles having an average diameter below 200 nm is obtained. This suspension is filtered to separate impurities such as dust, rubbings from grinding apparatus or hard agglomerates of the pigment used. A suitable choice of the pore size of the filter enables all impurities that are larger than the future layer thickness of the color filter to be removed from the suspension. If further additives, such as organic binders or an anti-foaming agent have been added to the suspension, it is advantageous to previously filter the corresponding additive solutions.

To apply and structure the color filter layer use can be made of different processes.

It is possible to provide the suspension obtained with a photosensitive additive that may contain, for example, polyvinyl alcohol and sodium dichromate. Subsequently the suspension is homogeneously applied to the inside of the display screen glass by means of spraying, dip coating or spin coating. The “wet” film is dried, for example, by heating, infrared radiation or microwave radiation. The color filter layer obtained is exposed through a mask and the exposed surfaces are cured. By spraying them with water, the unexposed regions are rinsed and removed.

It is alternatively possible to employ the so-termed “lift-off process”. In accordance with said process, first a photosensitive polymer layer is applied to the display screen glass and subsequently said polymer layer is exposed through a mask. The exposed surfaces cross-link and the unexposed surfaces are removed by means of a developing step. The remaining polymer pattern is subsequently provided, by means of spraying, dip coating or spin coating, with the pigment suspension on the inside of the display screen, which pigment suspension is subsequently dried. By means of a reactive solution, such as a strong acid, the cross-linked polymer is converted to a soluble form. By spraying with a developer, the polymer together with parts of the color filter layer present thereon are detached, while the color filter layer adhering directly to the display screen glass is not detached.

By means of said methods, a color filter layer is applied in the area of the blue phosphor, which color filter layer has a larger thickness than the red or blue color filter layer in the area of, respectively, the red or blue phosphors. This can be achieved, on the one hand, by preparing the color filter layer in the area of the green phosphor in a separate process step or by adding a non-linear photosensitive system to the suspension of the color filter pigment. By using different times of exposure for the areas in question, a color filter layer having different layer thicknesses is obtained. Such a non-linear photosensitive system may contain, for example, a water-soluble polymer such as polyvinyl alcohol (PVA) or polyvinyl pyrrolidone (PVP), which are sensitized by water-soluble bisazide derivatives such as sodium salts of diazostilbene, diazodibenzolactone or bisazido sulfobenzylidene cyclopentanone.

Subsequently, the grids of the three primary colors blue, red and green are applied in accordance with known methods in three successive photolithographic steps, using suspensions of pigmented phosphors. Alternatively, the phosphors can also be applied by a printing process.

The thermal post-treatment to which the display screen coating is subjected serves essentially to remove the additives from the different layers. The additives used, i.e. electrolytes, dispersing agents and polymeric binders, can be removed without leaving any residue by heating to a temperature in the range from 400 to 450° C.

In accordance with another embodiment of the invention, the display screen is initially manufactured without the unstructured filter layer and completely assembled. Subsequently, the second filter layer is provided on the outside of the glass front shell. In accordance with yet another embodiment the filter layer is applied as a coating to a foil and subsequently adhered to the outside of the front shell.

### EXAMPLE

The production of the display screen begins with a 17″ glass face panel that comprises a 2 cm thick glass plate. This is cleaned and dried.

For the neutral filter a solution is prepared comprising 7 g tetraethyl silicate, 86.3 g isopropyl alcohol, 3 g hydrochloric acid, 2 g water and 1 g hematite. The solution is prepolymerized at 25° C. for 3 hours. A quantity of 50 ml of this coating solution is spin coated onto the front shell at 200 rpm. After calcining at 120° C., a 50 nm thick layer of Fe₂O₃ pigments is obtained.

To manufacture the black matrix, the pretreated front shell is subsequently coated with a positively photosensitive resist and exposed as dictated by the positions of the red, blue and green emitting phosphor sub-pixels. By developing it, the photoresist is removed from the unexposed locations. Subsequently, a black layer with graphite pigments and binding agents is applied and dried at 60° C. By using acids, the photoresist and the black layer present thereon are removed at the location of the sub-pixels.

This glass face panel carrying the black matrix layer is washed with deionized water for one hour.

To manufacture a blue color filter layer, 60 g CoO—Al₂O₃ were stirred into a dispersant solution of 3.0 g of a sodium salt of a polyacrylic acid in 400 ml water. The suspension obtained was ground in a ball mill with glass balls. The ball mill was filled for approximately 50% and the rate of rotation was set to 60% of the critical rate of rotation. A stable suspension of the pigment particles having an average particle size of 85 nm was obtained.

After grinding, the suspension was diluted with water to a pigment concentration of 9% by weight and separated from the glass beads by using a straining cloth. The CoO—Al₂O₃-containing suspension was stable for a period of several weeks.

The suspension was mixed with a 10% polyvinyl alcohol solution, and the viscosity was reduced to approximately 30 mPa.s by adding water. In addition sodium dichromate was added to the suspension. The polyvinyl alcohol/sodium dichromate ratio was 10:1.

The suspension was spin coated onto a display screen glass and after drying a transparent blue color filter layer having a layer thickness of 1.0 μm and a pigment concentration of 3.2 wt. % was obtained. The layer was exposed to UV light through a mask as a result of which the polymer was cross-linked at the exposed locations. Subsequently the non-cross-linked color filter surfaces were removed by spraying with hot water.

The layer thickness and the pigment concentration of a blue color filter layer could be adjusted through the viscosity of the suspension. After applying and drying the suspension, the layer thickness was between 3 μm and 0.15 μm, and the pigment concentration was between 7.5 wt. % and 3.5 wt. %.

A blue color filter with CoO—Al₂O₃ having a layer thickness of 4 μm was prepared by making sure that the viscosity of the CoO—Al₂O₃-containing suspension was not reduced to below 50 mPa.s before it was applied to the display screen glass, and that the pigment concentration was maintained at 6 wt. %.

The display screen is then coated with the phosphor preparation by the flow coating process. For this purpose, the phosphor preparation containing a phosphor emitting in one color is suspended in a binder solution photoactivated with ammonium dichromate (ADC). The individual components of the phosphor suspension, i.e. phosphor powder, water, binder, dispersing agent, stabilizer and photosensitive component are mixed as a function of the particular phosphor and the processing conditions in a preset sequence and concentration given by a defined formulation. The suspension of the phosphor preparation is applied to the inside face of the prepared glass screen panel, which is rotating in the flow coating machine. The rotation of the display screen causes the phosphor suspension to become evenly distributed on it. Any excess suspension is centrifuged off. The wet layer of phosphor that has formed is dried. A shadow mask is mounted on the inside of the glass screen panel at some distance from the phosphor layer. The phosphor layer is irradiated with ultraviolet light through this shadow mask, as a result of which the irradiated areas of the phosphor layer are cured. The phosphor layer is developed with hot water, i.e. the uncured parts of the phosphor layer are removed. The structured phosphor layer is dried.

The above process steps are performed in succession with three phosphor preparations containing phosphors of the emission colors green, blue and red. The display screen is subsequently lacquered with a thin film of acrylate and a 200 nm thick layer of aluminum is then vapor deposited on it. The display screen is then fully heated at approximately 440° C. to remove any remaining organic components from the display screen coating.

A color cathode ray tube produced in this way is of increased efficiency and has an improved LCP factor.

Measuring Results:

Table 1 lists the improved LCP_{gain} values for a cathode ray tube comprising a blue structured color filter of CoAl₂O₄ having a layer thickness of 2.5 μm and the blue-emitting phosphor layer in combination with second optical filters of different materials.

LCP_{gain} is calculated as follows: LCP_{gain}=[LCP_{with filter}/LCP_{without filter}]×100.

D indicates the filter thickness, xₚₕₒₛₚₕₒᵣ and yₚₕₒₛₚₕₒᵣ relate to the color dot of the green phosphor, x_{body} and y_{body} relate to the color dot of the reflected white parking light D₆₅ (6.500 K). I_{red}, I_{green} and I_{blue} relate to the current requirement of each of the corresponding phosphors to generate white parking light D₆₅.

TABLE 1

| | d | | X | Y | X | Y | I | I | I |
|---|---|---|---|---|---|---|---|---|---|
| Filter | [μm] | LCP [%] | phosphor | phosphor | body | body | red | green | blue |
| Ce₂S₃ | 0.25 | 17 | 0.333 | 0.599 | 0.378 | 0.338 | 0.31 | 0.42 | 0.27 |
| Fe₂O₃ | 0.05 | 15 | 0.326 | 0.604 | 0.357 | 0.339 | 0.35 | 0.39 | 0.26 |
| TaON | 0.20 | 13 | 0.327 | 0.605 | 0.365 | 0.351 | 0.35 | 0.38 | 0.27 |
| Vst Red54 | 0.10 | 20 | 0.340 | 0.595 | 0.384 | 0.328 | 0.30 | 0.44 | 0.27 |
| Irgazin red | 0.05 | 15 | 0.332 | 0.601 | 0.382 | 0.351 | 0.32 | 0.40 | 0.28 |
| Mikrolith | 0.05 | 21 | 0.325 | 0.601 | 0.344 | 0.302 | 0.34 | 0.43 | 0.23 |
| Magenta | | | | | | | | | |
| Zapon | 0.30 | 19 | 0.313 | 0.602 | 0.313 | 0.284 | 0.38 | 0.42 | 0.21 |
| Violet 506 | | | | | | | | | |
| Ce₂S₃ | 0.25 | 17 | 0.333 | 0.599 | 0.378 | 0.338 | 0.31 | 0.42 | 0.27 |
| Fe₂O₃ | 0.05 | 15 | 0.326 | 0.604 | 0.357 | 0.339 | 0.35 | 0.39 | 0.26 |
| TaON | 0.20 | 13 | 0.327 | 0.605 | 0.365 | 0.351 | 0.35 | 0.38 | 0.27 |
| Vst Red54 | 0.10 | 20 | 0.340 | 0.595 | 0.384 | 0.328 | 0.30 | 0.44 | 0.27 |
| Irgazin red | 0.05 | 15 | 0.332 | 0.601 | 0.382 | 0.351 | 0.32 | 0.40 | 0.28 |
| Mikrolith | 0.05 | 21 | 0.325 | 0.601 | 0.344 | 0.302 | 0.34 | 0.43 | 0.23 |
| Magenta | | | | | | | | | |
| Zapon | 0.30 | 19 | 0.313 | 0.602 | 0.313 | 0.284 | 0.38 | 0.42 | 0.21 |
| Violet 506 | | | | | | | | | |

1. A color cathode ray tube provided with a front shell having an inner and an outer surface and a display screen coating on the front shell comprising a structured phosphor coating with phosphor grids for the colors red, green and blue and a filter system comprised of a first structured optical filter of the transmission type for the color blue and of a second unstructured optical filter.

2. A color cathode ray tube as claimed in claim 1, characterized in that the second optical filter is arranged on the inner surface of the front shell.

3. A color cathode ray tube as claimed in claim 1, characterized in that the second optical filter is arranged on the outer surface of the front shell.

4. A color cathode ray tube as claimed in claim 1, characterized in that the variation of the transmission Tₒₚₜ of the second optical filter in the visible wavelength range is smaller than 2.

5. A color cathode ray tube as claimed in claim 1, characterized in that the transmission T₆₀₀ of the second optical filter for light having a wavelength λ=600 nm is greater than the transmission T₅₅₀ for light having a wavelength λ=550 nm.

6. A color cathode ray tube as claimed in claim 1, characterized in that the transmission of T₄₅₀ of the second optical filter for light having a wavelength λ=450 nm is greater than the transmission T₅₂₀ of the second optical filter for light having a wavelength λ=520 nm.

7. A color cathode ray tube as claimed in claim 1, characterized in that the materials for the first optical filter include as a consistuent a pigment selected from the group composed of cobalt aluminate, ultramarine blue and phtalocyanine blue.

8. A color cathode ray tube as claimed in claim 1, characterized in that the materials for the second optical filter include as a constituent a pigment selected from the group composed of cerium sulphide Ce₂S₃, β-indium sulphide β-In₂S₃, hematite α-Fe₂O₃, tantalum oxide nitride TaON or an organic dye selected from the group composed of chlorinated Thioindigo Vat Red 54, dichlorodiketo-pyrrolopyrrole PR 254 (Irgazin, Ciba-Geigy), dichloro-quinacridone PR 202 (Mikrolith Magenta, Ciba-Geigy) and Zapon violet 506 S.V.2 (BASF).
